(19) United States
(12) Patent Application Publication
(10) Pub. No.: US 2015/0037709 A1
(43) Pub. Date: Feb. 5, 2015

(54) RENEWABLE, RECHARGEABLE, INEXPENSIVE ZINC/NATURAL CARBON/GRAPHITE AIR FUEL CELL

(71) Applicant: Joel Steven Goldberg, Hillsborough, NC (US)

(72) Inventor: Joel Steven Goldberg, Hillsborough, NC (US)

(21) Appl. No.: 14/057,506

(22) Filed: Oct. 18, 2013

Related U.S. Application Data
(60) Provisional application No. 61/861,521, filed on Aug. 2, 2013.

(51) Int. Cl. H01M 8/22

(52) U.S. Cl. CPC H01M 8/22
USPC 429/505

(57) ABSTRACT

This invention is a metal fuel cell that consumes zinc, oxygen and water. The chemistry of this fuel cell fundamental differs from other previously described metal air fuel cells because water is consumed and zinc and hydroxide anions are adsorbed by the natural carbon compounds of coal, charcoal and biochar. The adsorption of these ions is possible because of the accessible micropore structure of the natural carbon substances. The absorption limits the rate of fuel cell waste thereby decreasing the rate of increase of the cells internal resistance and this chemistry accounts for the fuel cell's longevity. The cell is inexpensive to make and renewable and rechargeable. Development of this cell could have profound effects on environmental, economic and social problems related to global energy.

### CROSS-REFERENCE TO RELATED APPLICATIONS

This application claims the benefit of U.S. Provisional Patent Application No. 61/861,521 filed Aug. 2, 2013 the contents of all of which are herein incorporated by reference in their entireties into the present patent application.

### STATEMENT REGARDING FEDERALLY SPONSORED RESEARCH OR DEVELOPMENT

Not applicable

### BACKGROUND OF THE INVENTION

Numerous metal/air fuel cells have been described and are in use. Most of these fuel cells are composed of a metal anode, graphite cathode and a basic electrolyte such as solutions of potassium hydroxide, manganese dioxide and ammonium chloride. The metal is oxidized at the anode and oxygen is reduced at the cathode. In these cells, metal and hydroxide ions are formed that bond to each other to form the metal hydroxide that then dissociates to form the metal oxide and water. These cells contain a corrosive electrolyte and the efficiency and longevity of the cell is limited by corrosion and the formation of the metal oxide as an end product. Water is not consumed.

This invention is a novel, inexpensive, renewable, rechargeable zinc/natural carbon/graphite/air fuel cell that utilizes water, oxygen and zinc as fuels. The cell can use water or salt solutions as an electrolyte. Because of the adsorptive properties of selected natural carbon substances defined as coal, charcoal or biochar, the cell produces minimal waste from metal oxides and electrolyte side reactions as found in traditional metal fuel cells or batteries, and as such, the internal ionic resistance of the cell remains stable for prolonged periods of discharge. The chemistry of this zinc/natural carbon/graphite/air fuel cell is fundamentally different than other metal fuels cells presently in use or that have been described. The charcoal and bituminous coal version of the cell can be recharged and the cell can be easily constructed with relatively inexpensive materials.

### BRIEF SUMMARY OF THE INVENTION

The zinc/natural carbon/graphite/air fuel cell can produce an electric current without a corrosive electrolyte and operates near neutral pH with minimal formation of zincate ion, zinc oxide and zinc hydroxide. This unique chemistry is possible because the natural carbon avidly adsorbs both zinc and hydroxide ions. The adsorption of zinc and hydroxide ions creates minimal waste in the form of oxides. This provides longevity to the cell because the internal ionic resistance of the cell does not increase as long as the waste products are buffered by the natural carbon substance. The adsorption of both zinc and hydroxide facilitates ionic movement within the cell. Furthermore, waste from corrosive electrolytes that may contribute to increases in internal resistance are not present and other impurities that could affect the cells internal resistance are buffered by the natural carbon substance.

Data is presented that the longevity of this fuel cell is related to the stability of the internal resistance of the cells and more specifically the ionic component of this resistance. Production of chemical waste increases ionic resistance by uncoupling or inhibiting redox reactions in the fuel cells.

### BRIEF DESCRIPTION OF THE DRAWINGS

A clear understanding of the key features of the invention summarized above may be had by reference to the appended drawings, which illustrates the method and system of the invention, although it will be understood that such drawings depict preferred embodiments of the invention and, therefore, are not to be considered as limiting its scope with regard to other embodiments which the invention is capable of contemplating. Accordingly:

FIG. 1 is an illustration of the method and system of this invention showing a simplified end-view diagram of a zinc/natural carbon/graphite air fuel cell. Container is labeled 1. Zinc anode is labeled 2. Natural carbon is labeled 3. Graphite is labeled 4. L represents the length of the fuel cell.

FIG. 2 is an illustration of the preferred embodiment of the invention. Connectors are labeled 1. Zinc anode is labeled 2. Natural carbon is labeled 3. Graphite is labeled 4. Plates of zinc and graphite offer an advantage over the construction shown in FIG. 1 because the cells can be inexpensively stacked with increased contact surfaces to increase total power.

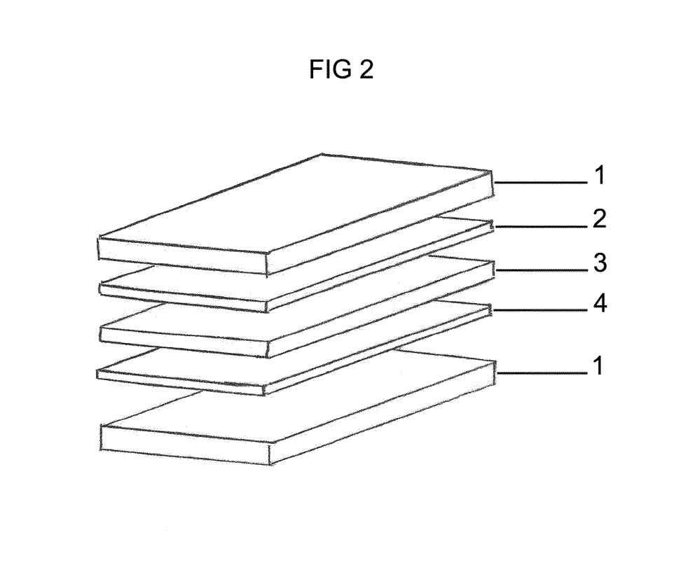

### DETAILED DESCRIPTION OF THE INVENTION

In a container, when a natural carbon substance such as bituminous coal, charcoal or biochar with a favorable micropore structure is placed between or in the surrounds of a zinc anode and graphite cathode in the presence of water and oxygen, a fuel cell is produce. The chemistry of this type of fuel cell has not been previously described. The large surface area of the micropore structure of the natural carbon adsorbs zinc and hydroxide ions with known ionic radii of 88 pm and 110 pm, respectively, and there is minimal formation of zincate ions, zinc oxide and zinc hydroxide which are waste. In previously described fuel cells, this waste production increases the internal ionic resistance of the fuel cell because the oxidation and reduction reactions are inhibited or inactivated according to Le Chatelier's principle. Unique to this cell, the adsorption of ions by the natural carbon substance produces a renewable, rechargeable inexpensive fuel cell with profound longevity limited by the depletion of the primary fuels zinc, water and oxygen and/or the depletion of the adsorptive capacity of the natural carbon substance.

Renewability of Cell

Zinc, unlike iron and aluminum, can be smelted from the oxide using concentrated solar power and is thus renewable. (Epstein M, Alde G, Santen S, Steinfeld A, Wieckert C. J Sol Energ-T Asme. February 2008; 130(1); Guillot E, Epstein M, Wieckert C, et al. SolarEngineering 2005. 2006:721-727; Wieckert C, Frommherz U, Kraupl S, et al. J Sol Energ-T Asme. May 2007; 129(2):190-196 and Steinfeld A. International journal of hydrogen energy. 2002; 27:611-619). Although bituminous coal is available and plentiful, eventually stores will be depleted and/or mining will become extraordinarily expensive. Charcoal or biochar can be made by man, is thus, renewable and the carbon dioxide produced is part of the natural carbon cycle. (Woolf D, Amonette J E, Street-Perrott F A Lehmann J, Joseph S. Nat Commun. 2010; 1:56). Graphite is not consumed in this fuel cell.

Natural Carbons

The natural carbon component of this fuel cell has favorable accessible micropores in sufficient quantity to adsorb zinc and hydroxide ions. (Chen X, Chen G, Chen L, et al. Bioresour Technol. October 2011; 102(19):8877-8884). Charcoals, biochar and bituminous coal, unlike anthracite or some activated charcoals, contain favorable accessible micropores.

Water

Distilled water, deep well water, fresh water, brackish water, sea water or saline can be used in this fuel cell. Addition of salt to the cell decreases the internal resistance and increases the rate of oxidation of zinc at the anode increasing the power output of the cell, but at the expense of longevity. Additional ions may compete for adsorption with zinc and hydroxide ions.

Rechargeablility

Both wet and dry zinc/charcoal/graphite fuel cells and wet zinc/bituminous coal/graphite cells are rechargeable.

Effects of Connecting Multiple Fuel Cells

This fuel cell can be connected in series to increase voltage or in parallel to increase amperage. Series and parallel cells can be connected for optimum power.

Environmental Considerations

The zinc/natural carbon/graphite air fuel cell converts chemical energy directly into electrical energy and is not subject to the inefficiencies of heat engines described by Carnot (steam production and rotation of turbines) and does not produce harmful greenhouse gases. The carbon dioxide produced by production of charcoal and biochar is part of the earth's natural carbon cycle, unlike the combustion of fossil fuels.

Benefits to Society

More than 1 billion people on our planet live without access to electricity. With available and affordable electricity comes a significant improvement in standard of living such as clean water from deep wells, agricultural technologies, and worldwide access to education and commerce via the internet. For those of us who are fortunate to have what appears to be an endless supply of electricity, we should learn from the mistakes of prior failed civilizations such as Easter Island, Mayan and Chacoan societies because they deforested their sources of energy. (Visalli D. Energy and ecology: why societies really succeed and fail. 2009. http://www.resilience.org/stories/2009-02-01/energy-and-ecology-why-societies-really-succeed-and-fail). Fossil fuels—the primary source of electrical energy in countries such as China, India, and the United States—are not renewable, but charcoal production if properly managed can be renewable. The zinc/natural carbon/graphite air fuel cell may fulfill many of the requirements of a renewable solution to global energy concerns.

Chemistry and thermodynamics of the zinc/natural carbon/graphite air fuel cell

(anode) Zn₍ₛ₎ [symbol] Zn⁺²+2e⁻ E⁰=0.77 V

(cathode) ½O_{2(g)}+H₂O+2e− [symbol] 2OH⁻ E⁰=0.34 V

(cell) Zn₍ₛ₎+½O_{2(g)}+H₂O [symbol] Zn⁺²+2OH⁻ E⁰=1.11 V

It is assumed that at neutral pH, [OH⁻]=10⁻⁷, the concentration of zincate ions (Zn(OH)₄²⁻) is very low, and that some zinc hydroxide (Zn(OH)₂) is formed. Therefore:

Kₛₚ of Zn(OH)₂=3×10⁻¹⁶

[Zn⁺²]=3×10⁻²

Nernst equation for a system not at equilibrium at 298K:

E=E⁰−0.0592V/n log Q

E=0.95 V,n=2,OH=[10-⁷],log Q=[Zn⁺²]/[OH⁻]²

E⁰=1.32V (best experimental)

Calculating ΔG⁰ from enthalpy of formation, and standard entropies

Zn₍ₛ₎+½O_{2(g)}+H₂O [symbol] Zn⁺²+20H⁻

### Reference Values of Standard Enthalpy of Formation

| | | |
|---|---|---|
| Zn⁺² | −153 | kJ/mol |
| H₂O | −286 | kJ/mol |
| OH⁻ | −230 | kJ/mol |
| O₂ | 0 | |

### Reference Values of Standard Entropy

| | | |
|---|---|---|
| Zn₍ₛ₎ | 42 | J/molK |
| Zn⁺² | −112 | J/molK |
| H₂O | 70 | J/molK |
| O₂ | 205 | J/molK |
| OH⁻ | −11 | J/molK |

### Standard Enthalpy Calculations

ΔH⁰_{f products}−ΔH⁰_{f reactants}

[Zn⁺²+2OH⁻]−[H₂O]

[−153+(2)−−230]−−286

ΔH_{f}⁰=−327 kJ/mol

### Standard Entropy Calculations

ΔS⁰_{products}−ΔS⁰_{reactants}

[Zn⁺²+2OH⁻]−[Zn₍ₛ+½O₂+H₂O]]

[−112+(2)(−11)]−[42+(0.5)205+70]

ΔS⁰=−348 J/molK

ΔS⁰=−0.348 kJ/molK

T=298K

TΔS⁰=−104 kJ/mol

ΔG⁰=ΔH°−TΔS⁰

ΔG⁰=−327 kJ/mol+104 kJ/mol

ΔG⁰=−223 kJ/mol using values of ΔH⁰_{f}

−ΔG⁰/nF=E⁰

ΔG kJ/mol,n=2,F=96,485 C/mol,E⁰=J/C

223/(2)(96,485)

E⁰=1.15 V using values of ΔH⁰_{f}

E⁰=0.780-0.935 V using experimental values

Theoretical limit of conversion of 1 mole of zinc into electrical energy=1.92×105 Coulombs

Discharge Properties of the Zinc/Natural Carbon/Graphite Air Fuel Cells

The cells produce low current (0.6-0.8 mA) and low voltage (0.5-0.8V) with a constant 1000Ω for prolonged periods of time because the ionic component of the internal resistance of the fuel cell increases very slowly. The extraordinary slow buildup of wastes in the form of metal oxides occurs because the natural carbons adsorb the metal and hydroxide ions. Internal resistance of the cells was calculated according to: (V_{100Ω}−V_{100Ω})/(I_{1000Ω}−I_{100Ω}).

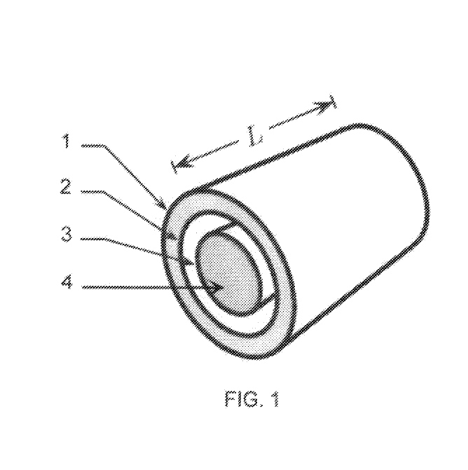

Table 1 shows discharge characteristics of zinc/charcoal/graphite fuel cell as designed in FIG. 1 and continuously connected to a 1000Ω resistor with periodic additions of aliquots of water.

TABLE 1
Discharge of zinc/charcoal/graphite fuel cell

| | | | | | Internal |
|---|---|---|---|---|---|
| | 10Ω | 100Ω | 1000Ω | 10,000Ω | resistance |
| Days | V/mA | V/ma | V/ma | V/mA | Ω |
| 1 | 0.1/11 | 0.51/5.2 | 0.83/.75 | 0.93/.08 | 72 |
| 2 | 0.06/10 | 0.35/4.6 | 0.68/0.72 | 0.77/0.07 | 85 |
| 7 | 0.05/7.4 | 0.29/4.1 | 0.64/0.75 | 0.78/0.08 | 104 |
| 38 | 0.02/2.5 | 0.18/2.2 | 0.56/0.6 | 0.78/0 | 237 |
| 83 | 0.02/3.1 | 0.17/2.2 | 0.51/0.6 | 0.69/0.07 | 212 |

Table 2 shows discharge characteristics of zinc/bituminous coal/graphite fuel cell as designed in FIG. 1 and continuously connected to a 1000Ω resistor with periodic additions of aliquots of water and addition of 54 g of sodium chloride on day 10.

TABLE 2
Discharge of zinc/bituminous coal/graphite fuel cell

| | | | | | Internal |
|---|---|---|---|---|---|
| | 10Ω | 100Ω | 1000Ω | 10,000Ω | resistance |
| Days | V/mA | V/mA | V/mA | V/mA | Ω |
| 1 | 0.03/3.4 | 0.24/2.5 | 0.67/0.73 | 0.93/0.09 | 243 |
| 2 | 0.03/3.2 | 0.22/2.6 | 0.65/0.75 | 0.83/0.09 | 232 |
| 7 | 0.02/0.05 | 0.16/0.02 | 0.52/0.56 | 0.72/0.02 | 667 |
| 38 | 0.03/0.11 | .24/1.2 | 0.5/0.51 | 0.72/0 | 377 |
| 83 | 0.005/0.2 | 0.006/0.17 | 0.11/0.1 | 0.44/0.05 | 1485 |

Table 3 shows weight of cells in Table 1 and 2.

TABLE 3
cell weights

| | Zinc | Natural | Graphite | |
|---|---|---|---|---|
| | (g) | carbon (g) | (g) | Water |
| Charcoal cell (Table 1) | 100 | 350 | 69 | 750 ml |
| Bituminous coal cell (Table 2) | 100 | 500 | 69 | 750 ml |

Experimental Data with Explanation of Tables

Table 4 shows that various natural carbon substances moistened with water will produce different electrical potentials when coupled to a graphite electrode. These data lead to optimum cathode materials of the fuel cell to consist of coconut shell biochar, non-activated charcoals and bituminous coal.

TABLE 4
Electrical potentials of various natural carbon/graphite
cathodes with stainless steel anode

| Cathode | Millivolts |
|---|---|
| Distilled water/graphite electrode (control) | 266 |
| Biochar-coconut shell/graphite electrode | 683 |
| Bituminous coal/graphite electrode | 524 |
| Artist charcoal/graphite electrode | 500 |
| Oil sandstone/graphite electrode | 480 |
| Biochar-corn husk/graphite electrode | 466 |
| Woodstock ™ hardwood charcoal/graphite electrode | 434 |
| Peat/graphite electrode | 392 |
| Oil shale/graphite electrode | 334 |
| Anthracite coal/graphite electrode | 224 |
| Light petroleum crude/graphite electrode | 201 |
| Lignite/graphite electrode | 107 |
| Kingsford ® compressed charcoal/graphite electrode | 97 |
| Activated charcoal/graphite electrode | |
| Food grade | 30 |
| Granular | <10 |
| Heavy petroleum crude/graphite electrode | 1 |

Table 5 shows generated electrical potentials with various anodes attached to a charcoal graphite electrode. Zn is the preferred anode for the fuel cell when compared to Al, Fe, Cu, Ag and Pt and the cathode connector can be any of the listed metals. Zinc is preferred presumably because the adsorption onto the charcoal is optimal. A wet cell version of this experiment (data not entered) further confirms that zinc is the preferred metal.

TABLE 5
Electrical potentials with anode and cathode connector
separated by charcoal/graphite electrode

| Anode | Cathode | |
|---|---|---|
| metal | connector | Volts |
| Zn | Zn | .935 |
| Zn | Al | .900 |
| Zn | Cu | .935 |
| Zn | Fe | .930 |
| Zn | Pt | .920 |
| Al | Zn | .500 |
| Fe | Zn | .430 |
| Cu | Zn | .003 |
| Ag | Zn | −.150 |
| Pt | Zn | −.225 |

Table 6 shows that the fuel cell unlike zinc alkaline batteries and zinc air fuel cells functions near neutral pH of 7.00 because the natural carbon adsorption of hydroxide buffers the cell.

TABLE 6
Interim pH measurements of zinc/natural carbon/graphite
air fuel wet cells During discharge

| | pH₁ | pH₂ | pH₃ | average pH |
|---|---|---|---|---|
| Zinc/charcoal/graphite | 7.02 | 7.11 | 7.11 | 7.08 |
| Zinc/bituminous coal/graphite | 6.82 | 6.97 | 6.7 | 6.83 |

Table 7 shows the longevity of wet and dry charcoal cells connected with an LED load. The charcoal cells could be recharged after they had discharged the energy required to light the LED. Aliquots of water were periodically added for fuel and as an electrolyte. The discharge capacity and number of recharges was not determined. The bituminous coal wet cell lit an LED for 144 days also requiring periodic additions of water. The bituminous coal cells were also rechargeable. The table further shows that step up of current could be achieved with series connections of cells.

TABLE 7
Duration of LED light from zinc/natural carbon/graphite air fuel cells with
addition of aliquots of water

| | Cell type | | | | | | |
|---|---|---|---|---|---|---|---|
| | Zn/natural | | | | | | |
| | carbon/ | | | | | Duration | |
| LED | graphite in | Number | | Initial | Initial | of light in | |
| Rating | grams | of cells | Connection | volts | mA | days | Rechargeable |
| LED₁ | Charcoal dry | 4 | Series | 3.2 | 20 | 48 | yes |
| 3.2 V/20 mA | 7.9/10/53 | | | | | | |
| LED₂ | Charcoal wet | 4 | Series | 3.4 | 20 | 53 | yes |
| 3.2 V/20 mA | 1.4/10/3.1 | | | | | | |
| LED₃ | Bituminous | 4 | Series | 3.1 | 50 | 144 | yes |
| 1.7 V/20 mA | coal wet | | | | | | |
| | 1.6/22.5/2.7 | | | | | | |

Table 8 shows that select hardwood charcoal and bituminous coal neutralize alkaline solutions presumably by the adsorption of hydroxide ions.

TABLE 8
Neutralization of hydroxide ions by natural carbons

| | | Grams | | | |
|---|---|---|---|---|---|
| | | natural | pH | pH after | Change |
| | Solution | carbon | initial | 24 hours | in pH |
| Bituminous | 100 ml | 25 | 9.84 | 8.29 | −1.55 |
| coal | NaOH in | | | | |
| | distilled | | | | |
| | water | | | | |
| Hardwood | 100 ml | 25 | 9.84 | 7.93 | −1.91 |
| Charcoal | NaOH in | | | | |
| | distilled | | | | |
| | water | | | | |

Table 9 shows that select anthracite coal does not neutralize an alkaline solution presumably because the micropore structure is not advantageous and therefore select anthracite coals are not acceptable natural carbons for this fuel cell. This confirms the observations previously shown in Table 4. However some activated carbons may neutralize an alkaline solution but those tested were not good natural carbons for the fuel cells.

TABLE 9
Failure of anthracite coal to neutralization an alkaline
solution and neutralization by select activated charcoal.

| | | Grams | | pH after 24 | |
|---|---|---|---|---|---|
| | | natural | pH | hours mean of | Change |
| | Solution | carbon | initial | 3 readings | in pH |
| Anthracite | 10 ml | 2.5 | 9.79 | 9.83 | +0.04 |
| coal | NaOH in | | | | |
| | distilled | | | | |
| | water | | | | |
| Activated | 10 ml | 2.5 | 9.79 | 7.67 | −2.12 |
| granular | NaOH in | | | | |
| charcoal | distilled | | | | |
| | water | | | | |

Table 10 shows that the internal resistance of the fuel cell can be decreased by the addition of graphite to charcoal without a change in the chemistry of the cell.

TABLE 10
Graphite powder decreases internal resistance

| | | 50 g charcoal and 2 g |
|---|---|---|
| | 50 g charcoal | graphite powder |
| mA | 0.53 | 0.69 |
| V | 0.49 | 0.78 |

### REFERENCES

Duracell. Technical Bulletin EOM Primary Systems. 2004. http://www.duracell.com/media/en-US/pdf/gtel/Technical_Bulletins/Zinc%20Air%20Tech%20Bulletin.pdf.
Adam J C. Improved and more environmentally friendly charcoal production system using a low-cost retort-kiln (Eco-charcoal). Renew Energ. August 2009; 34(8):1923-1925.
Antal M J. Charcoal production: The state of the art. Abstr Pap Am Chem S. Aug. 22 2010; 240.
Antal M J, Gronli M. The art, science, and technology of charcoal production. Ind Eng Chem Res. Apr. 16 2003; 42(8):1619-1640.
Kituyi E. Towards sustainable production and use of charcoal in Kenya: exploring the potential in life cycle management approach. J Clean Prod. 2004; 12(8-10):1047-1057.
Woolf D, Amonette J E, Street-Perrott F A, Lehmann J, Joseph S. Sustainable biochar to mitigate global climate change. Nat Commun. 2010; 1:56.
Agirre I, Griessacher T, Rosler G, Antrekowitsch J. Production of charcoal as an alternative reducing agent from agricultural residues using a semi-continuous semi-pilot scale pyrolysis screw reactor. Fuel Process Technol. February 2013; 106:114-121.
Khundi F, Jagger P, Shively G, Sserunkuuma D. Income, poverty and charcoal production in Uganda. Forest Policy Econ. March 2011; 13(3):199-205.
Anderson S A. Effects of surface chemistry on the porous structure of coal. In: Energy USDo, ed. Technical progress report 1997.
Franklin R E. A Study of the Fine Structure of Carbonaceous Solids by Measurements of True and Apparent Densities 0.2. Carbonized Coals. T Faraday Soc. 1949; 45(7):668-682.
Ecole polytechnique (France). Sadi Carnot et l'essor de la thermodynamique. Paris: Éditions du Centre national de la recherche scientifique; 1976.
Epstein M, Alde G, Santen S, Steinfeld A, Wieckert C. Towards the industrial solar carbothermal production of zinc. J Sol Energ-T Asme. February 2008; 130(1).
Guillot E, Epstein M, Wieckert C, et al. Solar carbothermic production of zinc from zinc oxide: Solzinc. Solar Engineering 2005. 2006:721-727.
Wieckert C, Frommherz U, Kraupl S, et al. A 300 W solar chemical pilot plant for the carbothermic production of zinc. J Sol Energ-T Asme. May 2007; 129(2):190-196.
Steinfeld A. Solar hydrogen production via a 2-step water-splitting thermochemical cycle based on Zn/ZnO redox reactions. International journal of hydrogen energy. 2002; 27:611-619.
Chen X, Chen G, Chen L, et al. Adsorption of copper and zinc by biochars produced from pyrolysis of hardwood and corn straw in aqueous solution. Bioresour Technol. October 2011; 102(19):8877-8884.
Leyva Ramos R, Bernal Jacome L A, Mendoza Barron J, Fuentes Rubio L, Guerrero Coronado R M. Adsorption of zinc(II) from an aqueous solution onto activated carbon. J Hazard Mater. Feb. 14 2002; 90(1):27-38.
Wilson K, Yang H, Seo C W, Marshall W E. Select metal adsorption by activated carbon made from peanut shells. Bioresour Technol. December 2006; 97(18):2266-2270.
Kalavathy H, Karthik B, Miranda L R. Removal and recovery of Ni and Zn from aqueous solution using activated carbon from Hevea brasiliensis: batch and column studies. Colloids Surf B Biointerfaces. Jul. 1 2010; 78(2):291-302.
Rao M M, Ramana D K, Seshaiah K, Wang M C, Chien S W. Removal of some metal ions by activated carbon prepared from Phaseolus aureus hulls. J Hazard Mater. Jul. 30 2009; 166(2-3):1006-1 adsorption of hydroxide ions. 013.
Bansode R R, Losso J N, Marshall W E, Rao R M, Portier R J. Adsorption of metal ions by pecan shell-based granular activated carbons. Bioresour Technol. September 2003; 89(2):115-119.
Visalli D. Energy and ecology: why societies really succeed and fail. 2009. http://www.resilience.org/stories/2009-02-01/energy-and-ecology-why-societies-really-succeed-and-fail.

Materials
Activated charcoal (Norit A Supra USP certified food grade)—Charcoal House®, Crawford, Nebr., USA
Activated charcoal (granular)—Black Diamond® Media, MARINELAND®, Cincinnati, Ohio, USA
Anthracite coal—ONATA, Toronto, Ontario, Canada
Bituminous coal—ONATA, Toronto, Ontario, Canada
Bituminous coal—Bridgers Coal and Farm Supply Inc., Wendell, N.C., USA
Compressed artist charcoal—PRO ART® Square Charcoal Sticks, Lansing, Mich., USA
Graphite (sawed)—½″×12″×6″ Oversized IG8SAW½×½×6, Small Parts and Bearings, Queensland, Australia
Graphite (pencil)—PRO ART®, Lansing, Mich., USA
Heavy crude oil—ONATA, Toronto, Ontario, Canada
Kingsford® original charcoal briquets—Oakland, Calif., USA
LED₁—Ultra High Brightness 10 mm Blue, FW supply: 3.2V FW current: 20 mA, #276-0006, RadioShack, Fort Worth Tex., USA
LED₂—Yellow LED, 3.0V 20 mA, #276-0021, RadioShack, Fort Worth Tex., USA
LED₃—Wide-Angle Red LED, FW supply: 1.7V 20 mA, #276-0309, RadioShack, Fort Worth Tex., USA
Light crude oil—ONATA, Toronto, Ontario, Canada
Lignite—ONATA, Toronto, Ontario, Canada
Multimeter—IDEAL 61-340, Sycamore, Ill., USA
Oil sandstone—ONATA, Toronto, Ontario, Canada
Oil shale—ONATA, Toronto, Ontario, Canada
Peat—ONATA, Toronto, Ontario, Canada
pH meter—BECKMAN Φ 10 pH meter, Fullerton, Calif., USA
Woodstock™ hardwood charcoal—Providence, R.I., USA
Zinc sheet—0.020″×12″×12″Rotometals, Inc., St. San Leandro, Calif., USA

Having described my invention, I claim:

1. A metal fuel cell comprising a container, water, air, cathode, anode and a natural carbon substance of coal, charcoal or biochar or any mixtures of these natural carbon substances in which the metal fuel cell consumes a metal, oxygen and water, including fresh water, brackish water, seawater or saline.

2. A fuel cell as in claim 1 in which graphite powder is mixed with coal, charcoal or biochar or any mixtures of these natural carbon substances.

3. A fuel cell as in claim 1 in which a salt is mixed with coal, charcoal or biochar or any mixtures of these natural carbon substances.

4. A fuel cell as in claim 1 in which a salt and graphite is mixed with coal, charcoal or biochar or any mixtures of these natural carbon substances.

5. A metal fuel cell comprising a container, zinc, graphite and natural carbon substance of coal, charcoal or biochar or any mixtures of these natural carbon substances in which themetal fuel cell consumes zinc, oxygen and water including fresh water, brackish water, seawater or saline.

6. A fuel cell as in claim 5 in which graphite powder is mixed with coal, charcoal or biochar or any mixtures of these natural carbon substances.

7. A fuel cell as in claim 5 in which a salt is mixed with coal, charcoal or biochar or any mixtures of these natural carbon substances.

8. A fuel cell as in claim 5 in which a salt and graphite is mixed with coal, charcoal or biochar or any mixtures of these natural carbon substances.
